(19) United States
(12) Patent Application Publication
(10) Pub. No.: US 2009/0136718 A1
(43) Pub. Date: May 28, 2009

(54) Reinforced Bonded Constructs

(76) Inventors: Paul Dacey, Newark, DE (US); Craig Lack, Hockessin, DE (US); Jeffrey Abramowicz, Springfield, MA (US)

Correspondence Address: GORE ENTERPRISE HOLDINGS, INC., 551 PAPER MILL ROAD, P. O. BOX 9206, NEWARK, DE, 19714-9206, US

(21) Appl. No.: 11/946,261

(22) Filed: Nov. 28, 2007

(51) Int. Cl. B32B 3/20

(52) U.S. Cl. 428/188

(57) ABSTRACT

An article having a bond with increased strength is described. In one embodiment, the article comprises a first material having a thermoplastic polymer, and a second material having an expanded polytetrafluoroethylene laminate joined by a welded bond. A reinforcing component is disposed between the first and second materials to form a reinforcing region.

### BACKGROUND OF THE INVENTION

The present invention relates generally to welding materials and in particular, to welding thermoplastic materials to form a bond having enhanced strength.

There exists in the art applications for textiles having a thermoplastic material adhered thereto. For example, U.S. Pat. No. 6,350,709 discloses a textile substrate having a polymeric film, such as polyamide, polyolefin, or polyurethane laminated thereto. This textile substrate may be woven of nylon, polyester, or other synthetic fibers. U.S. Pat. No. 6,350,709 also discloses a method for heat sealing sheets of the laminated material to form an automotive air bag.

When forming structures from materials having a thermoplastic layer thereon, bonds may be formed by placing materials between dies and applying energy. The polymeric films may be bonded through melting and curing.

### SUMMARY OF THE INVENTION

In one embodiment of the present invention, an article having a bond with increased strength is described. An article is described comprising two layers of dissimilar average peel strengths bonded together wherein a reinforcing component is bonded to the layer having a lower average peel strength. Bonds of the present invention are strong and durable.

In one embodiment, an article is described in which a first material having a thermoplastic polymer, and a second material having an expanded polytetrafluoroethylene (ePTFE) laminate, are joined by a welded bond. The ePTFE laminate of the second material comprises an ePTFE membrane and a textile layer. A reinforcing component, such as a polyurethane, is disposed on a portion of a surface of the second material to form a reinforcing region. The reinforcing component disposed on the second material is welded to the thermoplastic polymer of the first material to form a bond joining the first and second materials.

The reinforcing component is bonded to the second material for a distance beyond the area of the welded bond that joins the first and second materials. The reinforcing component is bonded to the second material beyond the welded bond to form a reinforcing region that extends in the direction of the welded bond that will be subject to a tensile load. The reinforcing region extending beyond the welded bond is sufficiently wide to increase the peel strength of the article to a desired strength that is greater than the average peel strength of the weakest material. Alternatively, the reinforcing region is sufficiently wide to increase the strength of the article to a strength greater than the peel strength achieved when the reinforcing region does not extend beyond the welded bond joining the first and second materials.

While one embodiment described herein is directed to a welded bond for bonding two layers around the peripheries to form an inflatable article, other applications can be envisioned for joining two layers of unequal peel strengths. For example, further embodiments include welded bonds for garment attachments such as pockets, patches, draw cord tunnels, and the like.

### DESCRIPTION OF THE DRAWINGS

The operation of the present invention should become apparent from the following description when considered in conjunction with the accompanying drawings, in which:

FIG. 1 is a schematic representation of an inflatable article according to one embodiment of the present invention.

FIG. 2 is a cross-sectional view illustrating a welded bond of an inflatable article.

FIG. 3 is a schematic representation of an inflatable article according to one embodiment of the present invention.

FIG. 4 is a cross-sectional view illustrating a welded bond of an inflatable article illustrated in FIG. 3.

FIG. 5 is a cross-sectional view illustrating a welded bond.

FIG. 6 is a cross-sectional view illustrating a welded bond according to an embodiment described herein.

FIG. 7 is a cross-sectional perspective photomicrograph according to one embodiment described herein of a welded bond according to an embodiment of the present invention.

FIG. 8 is a diagrammatic representation of a method for making a welded bond according to one embodiment of the present invention.

### DETAILED DESCRIPTION OF THE INVENTION

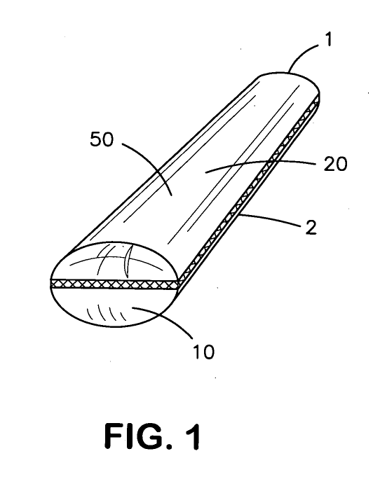

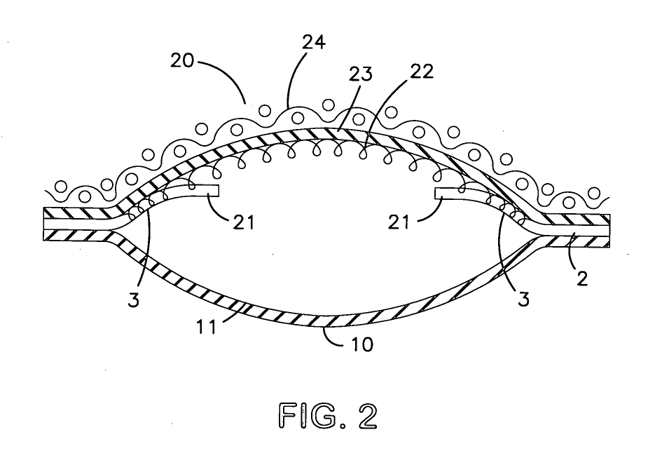

According to one embodiment of the present invention, FIG. 1 illustrates an inflatable article (1) that comprises a welded seam (2) that is capable of supporting a tensile load. The inflatable article (1) comprises a first material (10) and a second material (20) joined at the welded seam (2). The first material (10) and second material (20) are joined around peripheries to form a cavity (50) therebetween. The inflatable article may be adapted for connection to a gas supply such that the gas flows into the cavity to inflate the article. In one embodiment (FIG. 2), the first material (10) comprises a thermoplastic polymer (11) and the second material (20) comprises laminate comprising expanded polytetrafluoroethylene (ePTFE) (23) and a knit textile layer (22).

FIG. 2 is a cross-sectional representation of one possible inflatable article according to FIG. 1. The first material (10) comprises a thermoplastic polymer (11) such as a thermoplastic polyurethane. The second material (20) comprises a laminate of an ePTFE membrane (23) between two textile layers, an inner knit layer (22) and an outer woven layer (24). As further exemplified in FIG. 2, a reinforcing component (21) such as a thermoplastic polyurethane is bonded to a portion of a textile layer (22) of the second material (20) to form a reinforcing region(3). The first thermoplastic polymer (11) is bonded to at least a portion of the reinforcing region (3) to form the welded seam (2). In one embodiment, the reinforcing component (21) is bonded to the textile layer (22) of the second material (20) substantially through the thickness of the textile layer (22) when forming a reinforcing region.

In one embodiment, the reinforcing component (21) bonded to the second material (20) forming a reinforcing region (3), extends beyond the area of the welded seam (2) in a direction subject to tensile load. In an example where the article is an inflatable article, the direction of the tensile load is the side of the article subject to inflation pressure. Thus, in this embodiment, the reinforcing region (3) extends for a distance on the textile of the second material (20) beyond the width of the welded seam (2) inside of the inflatable cavity. The reinforcing region (3) extends beyond the welded seam (2), in the direction of the welded seam subject to tensile load, forming an area sufficiently greater than the welded seam to increase the strength of the welded seam joining first and second materials (10, 20).

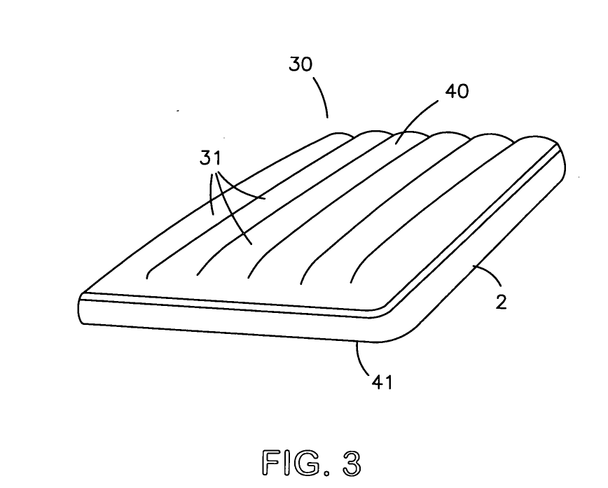

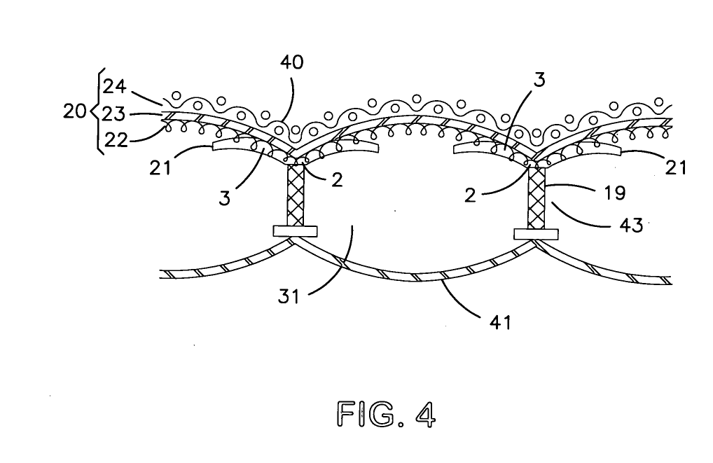

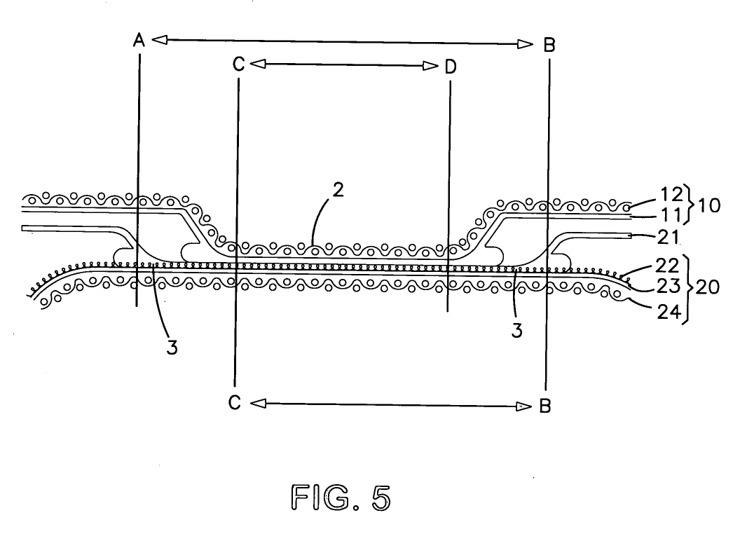

FIG. 3 illustrates an exemplary inflatable mattress (30) having parallel inflatable chambers (31) defined by welded seams capable of supporting a tensile load. FIG. 4 is a cross-sectional representation of a portion of the inflatable mattress of FIG. 3. An upper mattress surface (40) and a lower mattress surface (41) are joined by ribs (43) comprising a first material (10) to form the inflatable chambers (31). The upper mattress surface (40) comprises a second material (20), and the first and second materials (10, 20) are joined at welded seams (2). Reinforcing components (21) are bonded to a knit textile layer (22) of the second material (20) to form reinforcing regions (3) which may extend on both sides of a rib since the weld may be subject to a tensile load on both sides upon inflation of the chambers (31). The thermoplastic polymer of the ribs (43) is welded to a portion of the reinforcing regions (3). The reinforcing region (3) bonded to the textile of the second material (20) extends beyond the area of the welded seam (2) for a sufficient distance in the direction of tensile load to increase the bond strength so that the resulting peel strength is greater than the peel strength of the first and second materials welded together in the absence of a reinforcing region extending for a distance beyond the welded seam in the direction of the tensile load, or until a desired strength is achieved.

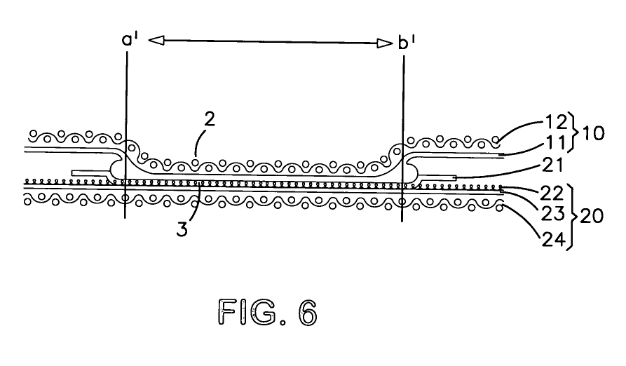

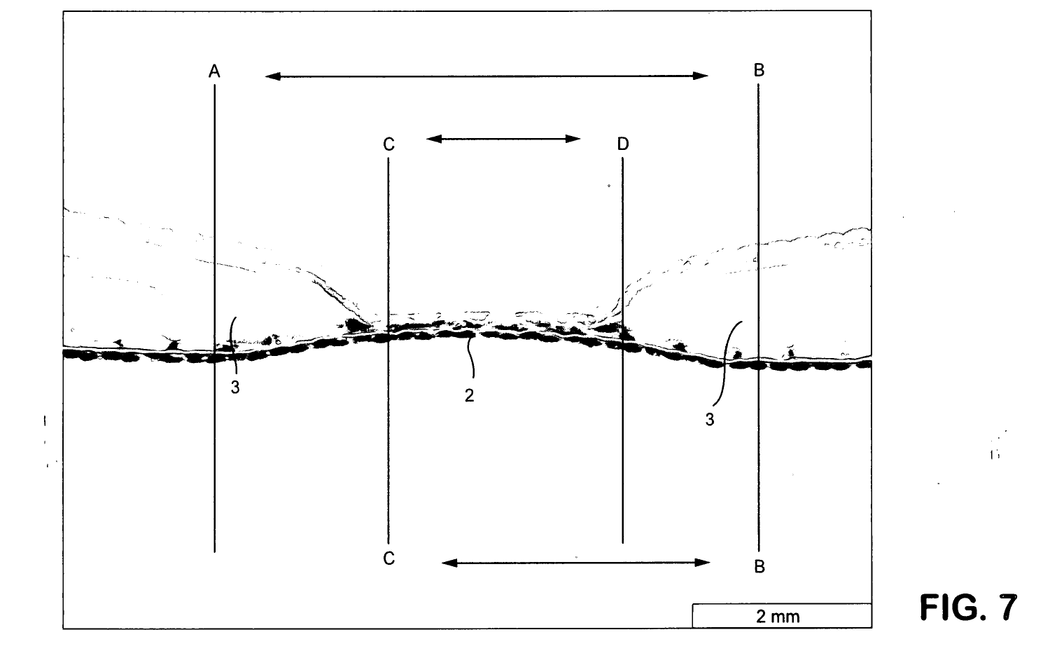

FIG. 5 illustrates a cross-section of a portion of an article having a welded seam, an example of which is further depicted in the micrograph of FIG. 7. A first material (10) comprises a first thermoplastic polymer (11) on a woven textile (12). The second material (20) comprises a woven layer (24), an ePTFE layer (23), and a knit layer (22). A reinforcing component (21) is bonded to the knit textile (22) of the second material (20) to form a reinforcing region (3) having a width defined approximately by line A-B of FIG. 5. To join the first (10) and second (20) materials, at least a portion of the reinforcing region (3) and the thermoplastic polymer (11) of the first material are bonded together to form the welded seam (2) having a width which is defined approximately by lines C-D of FIG. 5.

As illustrated in FIGS. 5 and 7, where the welded seam (2) and reinforcing region (3) are formed by heat and pressure, compressed areas are seen as the layers are pressed together in the bonding process.

In one embodiment, such as an inflatable article, where both sides of a welded seam may be subject to tensile load, the ratio of the reinforcing region (3) to the welded seam (2) is measured as approximately the width of the reinforcing region (line A-B) to approximately the width of the welded seam (line C-D), calculated as approximately line A-B/line C-D (FIGS. 5 and 7). In embodiments where only one side of a welded seam (2) is subject to tensile load, the reinforcing region may be measured as line C-B, and the ratio of the reinforcing region to the welded seam may be measured as the approximate width of the reinforcing region (line C-B) to the approximate width of the welded seam (approximately line C-D), calculated as line C-B/line C-D (FIGS. 5 and 7). In either calculation, the ratio of the width of the reinforcing region to width of the welded seam should be greater than 1. In either embodiment, the ratio of the width of the reinforcing region (3) to the width of the welded seam is greater than or equal to about 1.2. In other embodiments, the ratio of the width of the reinforcing region to the width of the welded seam is greater than or equal to about 1.5, or greater than or equal to about 1.7, or greater than or equal to about 1.9, or greater than or equal to about 2, or greater than or equal to about 2.5, or greater than or equal to about 3, or greater than or equal to about 3.5, or greater than or equal to about 4, or greater than or equal to about 4.5.

FIG. 6 illustrates an example of a welded seam wherein a reinforcing component (21) is bonded to the textile layer (22) of a second material (20) to form a reinforcing region (3) that does not extend substantially beyond the welded seam (2) (defined by line a′-b′ in FIG. 6). Thus, the ratio of reinforcing region (also line a′-b′) to welded seam is approximately 1.

The first material (10) comprises a first thermoplastic polymer (11) which can be a thermoplastic polyurethane. The thermoplastic polymer may be a film with or without an additional layer. The first material (10) may be a laminate comprising at least one additional layer, for example, the thermoplastic polymer (11) can be in the form of a film or a coating laminated to, for example, a woven, non-woven or knit textile layer (12). The first material (10) has an average peel strength greater than the average peel strength of the second material (20) when tested according to the method disclosed herein for peel strength.

The second material (20) comprises expanded polytetrafluoroethylene (ePTFE). In one embodiment, the ePTFE is laminated to a textile. The textile to which the reinforcing component is bonded may be a knit, woven, or non-woven material. The second material (20) may further comprise a second textile attached to the ePTFE. The second textile layer may also be a knit, woven, or non-woven. The second material may have a weight of less than about 10 oz/yd² (339 g/m²). The second material (20) has an average peel strength less than the average peel strength of the first material (10) when tested according to the method disclosed herein for peel strength. Briefly described, the average peel strength of the first material and the average peel strength of the second material are calculated by bonding two pieces of a first material together, bonding two pieces of a second material together, and testing and measuring the peel strength for several samples of each material according to the described method.

The reinforcing component may comprise a thermoplastic polymer, such as polyurethane, polyester, elastomer, nylon, or the like, or may be a thermosetting polymer such as a thermosetting polyurethane. The reinforcing component may have a thickness greater than about 4 mil, greater than about 6 mil, or greater than about 8 mil. In certain applications thicker reinforcing components may be desired having a thickness greater than about 10 mil, or greater than about 12 mil. In one embodiment the reinforcing component bonds directly to ePTFE. In another embodiment, where the second material is a laminate of ePTFE and a textile layer, the reinforcing component bonds directly to the ePTFE of the second material to form a reinforcing region. In another embodiment the reinforcing component bonds to the textile layer of the second material, and in another embodiment, the reinforcing component penetrates substantially entirely through the thickness of the textile (22) of the second material (20) to form the reinforcing region (3).

In one embodiment, a first material (10) is joined to a second material (20) at a welded seam (2), and the second material has a weight of less than about 10 oz/yd² (339 g/m²). The welded seam joining the first and second materials has a peel strength greater than the average peel strength of the second material (20) when the peel strength of the welded seam and the average peel strength of the second material are tested according to the method disclosed herein for peel strength. In one embodiment, the welded seam joining the first and second material has a peel strength greater than about 20 pli, greater than about 22 pli, greater than about 24 pli, or greater than about 25 pli when measured according to the method described herein for peel strength. In one embodiment where the weight of the second material is less than about 10 oz/yd² (339 g/m²), the welded seam has a peel strength greater than about 20 pli, greater than about 26 pli, greater than about 28 pli, greater than about 30 pli, greater than about 35 pli, greater than about 38 pli, or greater than about 40 pli when measured according to the test disclosed herein for peel strength.

Articles having welded seams with reinforced regions can be made with heat sealing equipment known in the art, such as radio frequency welding equipment, for example, welders made by Thermex-Thermatron, Inc. (Hauppauge, N.Y.).

Methods for joining the first material (10) and the second material (20) with a welded seam having a reinforcing region are provided herein. In one embodiment, a method is provided for increasing the peel strength of an article to a strength greater than the average peel strength of the weaker of the two materials to be joined. The average peel strength of each material is determined by the method described herein. The peel strength of an article formed by methods described herein may be measured according to the method described herein.

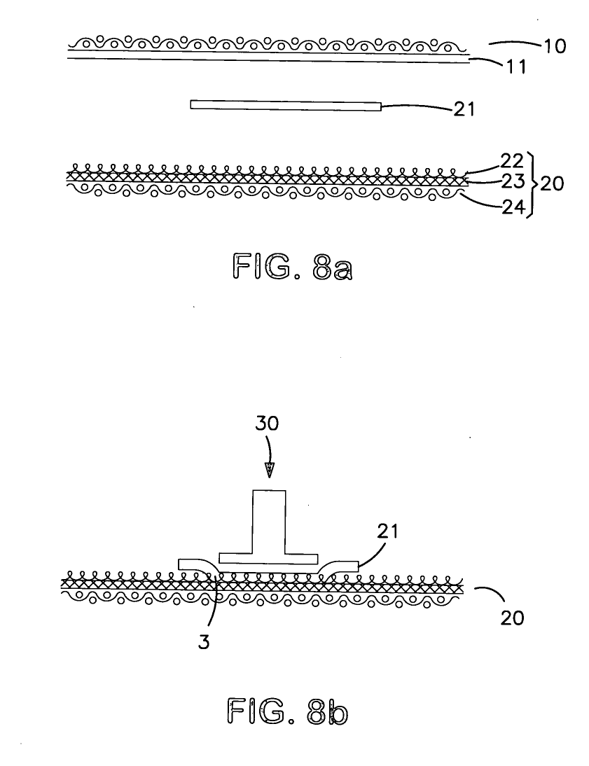

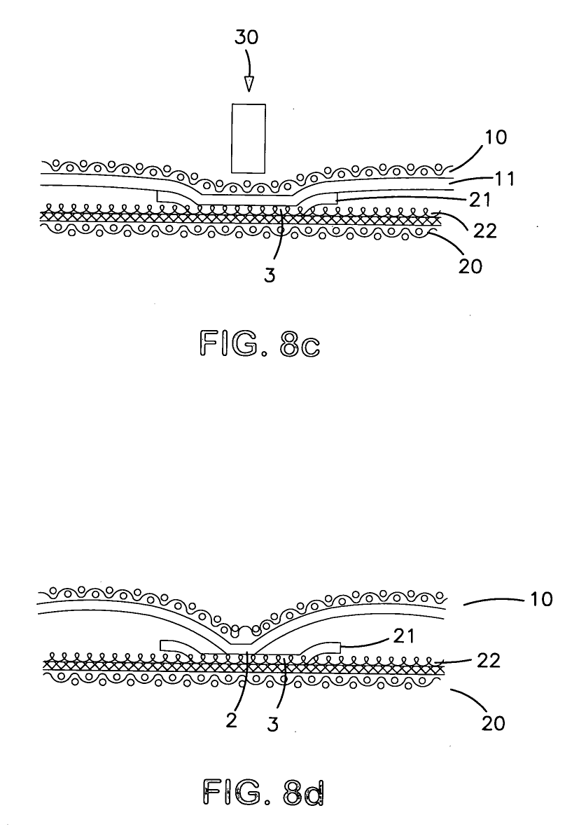

The following method steps exemplified in FIG. 8 (FIGS. 8a-8d) may be used to join first and second materials. A method comprises providing a first material (10) comprising a thermoplastic polymer layer (11) and providing a second material (20) comprising an ePTFE-textile composite material that has an average peel strength less than the average peel strength of the first material (FIG. 8a).

Further, the method comprises providing a reinforcing component (21) to a portion of the second material, and providing heat and pressure with anvil (30) in the direction of the arrow (FIG. 8b) melting the reinforcing component onto the textile (22) side of the second material to form a reinforcing region (3). The method further comprises aligning the first thermoplastic polymer (11) over at least a portion of the width of the reinforcing region (3), applying heat and pressure with anvil (30), and melting the first thermoplastic polymer (11) and the reinforcing region (3) to form a welded seam (2) (FIG. 8c). In one embodiment the thermoplastic polymer of the first material is bonded to the reinforcing region forming a welded seam (2) having a width that is less than the width of the reinforcing region (FIG. 8d).

### Test Methods

### Peel Test for Seam Strength

To determine the peel strength of a welded bond, or welded seam, an Instron tensile test was performed. This procedure is based generally on the description in ASTM D 5822-03, Standard Test Method for Determing Seam Strength in Inflatable Restraint Cushions. Test sample width was modified from the specified test standard of four (4) inch wide to be one (1) inch wide. This procedure provides a pulling force that is perpendicular (tension) to the welded seam. The strain (amount of elongation) and the load at break is the output that is measured and recorded from this test protocol. The load at break is referred to herein as the peel strength.

The test samples are prepared by die cutting a 1 inch (2.54 cm) by 6 inch (15 cm) test specimen with the welded seam parallel to the 1″ wide direction. The sample is clamped at each end and then pulled at a rate of about 12 inches (31 cm) per minute until the test is completed. The test is completed when the yield point of the stress/strain curve has been exceeded or a visual defect is observed. Visual defects for completing the test include a knit fracture, separation of any layers in the composite being welded, or any fracture of the polyurethane weld itself. The seam strength is then reported as the maximum load (in pounds force) that the tested weld seams reached prior to the test being completed. The results are reported in units of pounds force per linear inch.

### Average Peel Strength of Material

To determine the average peel strength of the first and second materials, samples of each material were prepared as follows. Two layers of the first material (10) are bonded together with 12 mils of polyurethane (3 layers of 4 mil film). Where the first material (10) comprises a polyurethane-coated textile, the polyurethane-coated surface of the textile is placed in contact with the 12 mils of polyurethane (3 layers of 4 mil film). RF energy and pressure is applied to the textile surface of the first material (10) to melt the polyurethane coating and polyurethane film to form a weld between the materials. Five samples are tested, where possible, to determine the average peel strength of the material. The testing is performed substantially in accordance with the method described herein for Peel Test for Seam Strength. This same process is repeated for the second material (20) to determine the average peel strength of the second material. The average peel strengths of the first material (10) and second material (20) are compared.

Without intending to limit the scope of the present invention, the following examples illustrate how the present invention may be made and used.

### EXAMPLES

### Example 1

A sample was formed bonding a first material comprising a polyurethane-coated textile layer to a second material comprising an air permeable three-layer ePTFE laminate, wherein the first and second materials were joined without forming a reinforcing region between the two materials at the welded seam.

A polyurethane-coated textile (from Highland Industries, Greensboro, N.C.), was provided. The textile was a 70 denier, 1.9 oz/yd² (64 g/m²) woven nylon taffeta with a polyurethane coating weight of about 3.2 oz/yd² (109 g/m²).

A three-layer laminate that was moisture vapor permeable and air permeable (#WAAZ100604M; W.L. Gore & Associates, Elkton, Md.) was provided. The three-layer laminate comprised an expanded polytetrafluoroethylene membrane (ePTFE), and a 1.8 oz/yd² (61 g/m²) polyester knit layer and a woven layer (70 denier nylon taffeta) laminated by a discontinuous adhesive process, on either side of the ePTFE membrane.

The polyurethane-coated textile was bonded to the air permeable three-layer laminate as follows. The materials were arranged so that the polyurethane-coated surface of the textile was in contact with the knit side of the three-layer laminate. The materials were bonded by RF welding with a single bed, **K tube RF welder with 10 kW power (Thermex-Thermatron, Inc., Hauppauge, N.Y.) as radio frequency (RF) energy and pressure were applied to the textile surface of the polyurethane-coated textile to melt the polyurethane coating forming a weld between the materials. The width of the anvil was selected to form a weld having a width of about ¼ inch as indicated in Table 1. The weld was about 8 inches (20 cm) long.

Five test strips were cut from the sample for peel strength testing according to the method provided herein. The average peel strength (pli) value is provided in the Table 1.

### Examples 2-3

Samples were formed bonding a first material comprising a polyurethane-coated textile layer and a second material comprising an air permeable three-layer ePTFE laminate. The first and second materials were joined by a welded seam comprising a reinforcing region formed from 6 mils of polyurethane as a reinforcing component. For Example 2, the width of the reinforcing region was substantially the same width as the welded seam. For Example 3, the reinforcing region extended beyond the welded seam. The samples were prepared as follows.

A first material, a polyurethane-coated textile (as described in Example 1), was provided. The textile was a woven nylon taffeta.

A second material was provided comprising a three-layer ePTFE laminate. The three-layer laminate was moisture vapor permeable and air permeable (as described in Example 1). The laminate comprised a polytetrafluoroethylene membrane, and a 1.8 oz/yd² (61 g/m²) polyester knit layer and a woven layer (70 denier nylon taffeta) on either side of the ePTFE membrane.

The 6 mil polyurethane film was provided as two layers of 3 mil polyurethane film (PS 8010 NAT from Deerfield Urethanes, Whately, Mass.), which was stacked and bonded to the knit side of the second material using a Thermatron radio frequency welder as specified in Example 1. A first weld was formed joining the 6 mils of polyurethane and the second material to forming reinforcing region. The width of the anvil was selected to form a first weld width having a width as indicated in Table 1. The first weld had a length of about 8 inches (20 cm) long.

The first and second materials were arranged so that the polyurethane-coated surface of the first material was in contact with the second material along the length of the first weld. A second weld was formed as radio frequency (RF) energy and pressure was applied to the textile surface of the first material to melt the polyurethanes of the first material and the reinforcing region on the second material together. The RF welding equipment was positioned so that the width of the RF welding anvil forming the second weld was centered and parallel with the width of the first weld joining the first and second materials together at a welded seam.

The width of the RF welding anvil used to form the second weld was selected to produce a welded seam having a width as indicated in Table 1, and a length of about 8 inches long. As exemplified in FIG. 5, line A-B corresponds to the first weld wherein the 6 mils of polyurethane is bonded to the knit of the second material to form the reinforcing region. Line C-D corresponds to the second weld, forming the welded seam joining the first material and the reinforcing region on the second material. A reinforcing region is formed from the portion of polyurethane film bonded to the knit side of the second material for the distance of the welded seam and, for Example 3, for a distance extending beyond the welded seam in the direction of the tensile load, shown as line C-D in FIG. 5.

Where the width of the anvil used for the first weld was greater than the width of the anvil selected for the second weld, a reinforcing region was formed on the textile of the second material. The width of the first weld bonding the 6 mils of polyurethane to the second material was greater than the width of the second weld joining the first and second materials, in the Examples having a ratio of CB/CD greater than 1 (Table 1) as exemplified in the micrograph of FIG. 7, which was prepared substantially according to Example 6.

Five test strips were cut from each sample for peel strength testing according to the method provided herein. The average values are provided in the table. Advantageously, samples having a reinforcing region on the second material extending for a distance beyond the second weld in the direction of the tensile load, showed high peel strength values when tested according to the methods described above (Table 1).

TABLE 1
Peel Strength of Air-Permeable ePTFE Composite
Welded to Polyurethane-Coated Textile.

| | | Reinforcing | | Average |
|---|---|---|---|---|
| | Welded Seam | Region inches | Approximate | Peel |
| Example | inches (mm)* | (mm)* | Ratio | Strength |
| No. | (line C-D) | (line C-B) | CB/CD | (pli) |
| 1 | ¼″ (6 mm) | — | — | 13 |
| 2 | ¼″ (6 mm) | ¼″ (6 mm) | 1 | 15 |
| 3 | ¼″ (6 mm) | ⅜″ (10 mm) | 1.5 | 21 |
| 4 | ¼″ (6 mm) | ¼″ (6 mm) | 1 | 19 |
| 5 | ¼″ (6 mm) | ⅜″ (10 mm) | 1.5 | 29 |
| 6 | ⅛″ (3 mm) | 3/16″ (5 mm) | 1.5 | 30 |
| 7 | ⅛″ (3 mm) | 5/16″ (8 mm) | 2.5 | 32 |
| 8 | ⅛″ (3 mm) | 9/16″ (14 mm) | 4.5 | 37 |

*approximate

### Examples 4-8

Samples were formed bonding a first material comprising a polyurethane-coated textile layer and a second material comprising an air permeable three-layer ePTFE laminate. The first and second materials were joined by a welded seam comprising a reinforced bonding region formed from 12 mils of polyurethane as a reinforcing component. For Example 4, the width of the reinforcing region was substantially the same width as the welded seam. For Examples 5-8, the reinforcing region extended beyond the welded seam. The samples were prepared as follows.

Each sample was prepared substantially in accordance with the method and materials of Examples 2-3, with the exception that the 12 mils of polyurethane was provided as three layers of 4 mil polyurethane film (#PS 8010 from Deerfield Urethanes, Whately, Mass.) stacked and bonded to the knit side of the second material comprised of an air permeable three-layer ePTFE laminate. The size of the anvils were selected to form welded seams (line C-D) and reinforcing regions (line C-B) having widths (measured in inches) as indicated in Table 1.

The width of the first weld bonding the 12 mils of polyurethane to the second material to form the reinforcing region was greater than the width of the second weld joining the first and second materials for samples having a ratio of CB/CD greater than 1 as exemplified in the optical micrograph of FIG. 7, prepared substantially according to Example 6. Five test strips were cut from each sample for peel strength testing according to the method described herein. The average values are provided in the Table 1. Advantageously, samples having a ratio of the reinforcing region to welded seam greater than about 1, where the reinforcing region bonded on the second material extends for a distance beyond the welded seam (joining the first and second materials), in the direction of the tensile load, showed high peel strength values when tested according to the method described above (Table 1).

### Example 9

A sample was formed joining a first material comprising a polyurethane-coated textile layer to a second material comprising an air impermeable three-layer ePTFE laminate, wherein the first and second materials were joined without forming a reinforcing region at the welded seam.

A first material comprising a polyurethane-coated textile (as described in Example 1), was provided. The textile was a woven nylon taffeta. A second material comprising a three-layer laminate that was moisture vapor permeable and air impermeable was provided. The laminate comprised a polytetrafluoroethylene membrane having an air impermeable polyurethane coating with a thickness of about 3 mils, a 1.8 oz/yd² (61 g/m²) knit layer attached to the side of the membrane having the air impermeable coating, and a woven layer (70 denier nylon taffeta) on the side of the ePTFE membrane opposite the knit.

The first and second materials were arranged so that the polyurethane-coated surface of the first material was in contact with the knit side of the second material. A weld was formed as radio frequency (RF) energy and pressure as specified in Example 1 were applied to the textile surface of the first material to melt the polyurethane and joining the first and second material.

The RF welding anvil selected formed a weld having a width of about 1 inches (6 mm). Five test strips were cut from each sample for peel strength testing according to the method provided herein. The average peel value is provided in Table 2.

### Examples 10-11

Samples were formed bonding a first material comprising a polyurethane-coated textile layer to a second material comprising an air impermeable three-layer ePTFE laminate. The first and second materials were joined by a welded seam comprising a reinforced bonding region formed from 6 mils of polyurethane as a reinforcing component. For Example 10, the width of the reinforcing region was substantially the same as the width of the welded seam; for Example 11, the reinforcing region extended beyond the welded seam.

A first material, a polyurethane-coated textile (as described in Example 1), was provided. The textile was a woven nylon taffeta.

A second material comprised of an air impermeable three-layer ePTFE laminate was provided. The three layer laminate was moisture vapor permeable and air impermeable (as described in Example 9). The laminate comprised a polytetrafluoroethylene membrane having an air impermeable polyurethane coating, a 1.8 oz/yd² (61 g/m²) polyester knit layer attached to the side of the membrane having the air impermeable coating, and a woven layer (70 denier nylon taffeta) on the side of the ePTFE membrane opposite the knit.

The 6 mils of polyurethane was provided as two layers of 3 mil polyurethane film (#PS 8010 NAT, Deerfield Urethanes, Whately, Mass.) stacked and bonded to the knit side of the second material using the RF welding equipment and specifications as described in Example 1, forming a first weld having a length of about 8 inches (20 cm). The first and second materials were arranged so that the polyurethane-coated surface of the first material was in contact with the second material along the length of the first weld. A second weld was formed as radio frequency (RF) energy and pressure were applied to the textile surface of the first material to melt the polyurethanes of the first and second materials together, joining the two materials at a welded seam. The RF welding equipment was positioned so that the welding anvil forming the second weld was centered and parallel with the width of the first weld forming a reinforced bond region. The width of the RF welding anvil used to form the second weld was selected to produce a welded seam having a width as indicated in Table 2.

As exemplified by the illustration in FIG. 5, line A-B shows the width of the first weld wherein the polyurethane of the 6 mil polyurethane sheet is bonded to the knit of the second material. Line C-D shows the width of the welded seam. A reinforcing region is formed which corresponds to the portion of the polyurethane film bonded to the knit side of the second material for the width of the welded seam and for an additional distance extending beyond the welded seam in the direction of the tensile load, shown by line D-B in FIG. 5. Where the width of the anvil used for the first weld was greater than the width of the anvil selected for the second weld, a reinforcing region was formed on the textile of the second material.

The width of the first weld bonding the 6 mils of polyurethane to the second material was greater than the width of the second weld joining the first and second materials for samples having a ratio of CB/CD greater than 1 as exemplified in the optical micrograph of FIG. 7, prepared substantially according to Example 6.

Five test strips were cut from each sample for peel strength testing according to the method described herein. The average values are provided in Table 2. Advantageously, samples having a reinforcing region bonded to the second material extending for a distance beyond the welded seam in the direction of the tensile load showed high peel strength values when tested according to the method described above.

### Examples 12-16

Samples were formed joining a first material comprising a polyurethane-coated textile layer and a second material comprising an air impermeable three-layer ePTFE laminate. The first and second materials were joined by a welded seam comprising a reinforcing region formed from 12 mils of a polyurethane reinforcing component.

Each sample was prepared substantially in accordance with the method and materials of Examples 10-11, with the exception that 12 mils of polyurethane was provided as three layers of 4 mil polyurethane film (#PS 8010 NAT, Deerfield Urethanes, Whately, Mass.) stacked and bonded to the knit side of the second material comprised of a three-layer ePTFE laminate. The size of the anvils were selected to form first and second welds having the widths as indicated in Table 2.

Five test strips were cut from each sample for peel strength testing according to the method described herein. The average values are provided in Table 2. Advantageously, samples having a first weld bonding the polyurethane film to the second material for a distance beyond the welded seam in the direction of the tensile load, showed high peel strength values when tested according to the method described above (Table 2).

TABLE 2
Peel Strength of Air-Impermeable ePTFE Composite
Welded to Polyurethane-Coated Textile.

| | Welded Seam | Reinforcing Region | Approximate | |
|---|---|---|---|---|
| Sample | inches (mm)* | inches (mm)* | Ratio | Mean Peel |
| No. | (line C-D) | (line C-B) | CB/CD | Strength |
| 9 | ¼″ (6 mm) | — | — | 14 |
| 10 | ¼″ (6 mm) | ¼″ (6 mm) | 1 | 18 |
| 11 | ¼″ (6 mm) | ⅜″ (10 mm) | 1.5 | 21 |
| 12 | ¼″ (6 mm) | ¼″ (6 mm) | 1 | 19 |
| 13 | ¼″ (6 mm) | ⅜″ (10 mm) | 1.5 | 35 |
| 14 | ⅛″ (3 mm) | 3/16″ (5 mm) | 1.5 | 37 |
| 15 | ⅛″ (3 mm) | 5/16″ (8 mm) | 2.5 | 39 |
| 16 | ⅛″ (3 mm) | 9/16″ (14 mm) | 4.5 | 48 |

*approximate

The invention claimed is:

1. An article comprising
a first material and a second material joined at a welded seam capable of supporting a tensile load;
the first material comprising a first thermoplastic polymer, and the second material comprising a laminate of an ePTFE membrane and a textile layer; and
a reinforcing component bonded to a portion of the textile layer of the second material to form a reinforcing region, at least a portion of the reinforcing region bonded to the first thermoplastic polymer of the first material to form the welded seam;
wherein the reinforcing region is bonded to the textile layer of the second material in the direction of the tensile load for a distance beyond the welded seam.

2. The article of claim 1 wherein the ePTFE membrane comprises a polyurethane coating.

3. The article of claim 2 wherein the polyurethane coating is on the side of the ePTFE membrane onto which the textile is laminated.

4. The article of claim 1 wherein the reinforcing component is a thermoplastic polymer.

5. The article of claim 1 wherein the reinforcing component substantially penetrates the thickness of the textile layer of the second layer.

6. The article of claim 1 wherein the ratio of the width of the reinforcing region to the width of the welded seam is greater than about 1.

7. The article of claim 1 wherein the ratio of the width of the reinforcing region to the width of the welded seam is greater than about 1.5.

8. The article of claim 1 wherein the first thermoplastic polymer of the first material is a polyurethane.

9. The article of claim 1 wherein the first material further comprises a textile.

10. The article of claim 1 wherein the first thermoplastic polymer of the first material is applied as a coating to a textile layer.

11. The article of claim 1 wherein the first material is a thermoplastic polymer film.

12. The article of claim 1 wherein the laminate of the second material comprising an ePTFE membrane and a textile layer has a weight of less than about 10 oz/yd².

13. The article of claim 12 wherein the first and second materials are bonded together to form a welded seam having a break strength greater than about 20 pli.

14. The article of claim 12 wherein the first and second materials are bonded together to form a welded seam having a break strength greater than about 30 pli.

15. An inflatable article comprising
a first material and a second material, the second material having an average peel strength less than the average peel strength of the first material,
the first material comprising a first thermoplastic polyurethane,
a second material comprising a laminate of an expanded polytetrafluoroethylene (ePTFE) membrane and a textile layer; and
a reinforcing component bonded to a portion of the textile of the second material to form a reinforcing region on the second material,
the first thermoplastic polyurethane of the first material and at least a portion of the reinforcing region are bonded to form a welded seam around peripheries of the first and second materials to form a cavity;
the reinforcing region extending in the direction of the cavity on the textile layer of the second material for a distance beyond the welded seam, and
the cavity being adapted for connection to a gas supply such that the gas flows into the cavity to inflate the article.

16. The inflatable article of claim 15 wherein the ePTFE membrane further comprises a polyurethane coating.

17. The inflatable article of claim 15 wherein the reinforcing component has a thickness of greater than about 4 mil.

18. The inflatable article of claim 15 wherein the ratio of the width of the reinforcing region to the width of the welded seam is greater than about 1.

19. The inflatable article of claim 15 wherein the ratio of the width of the reinforcing region to the width of the welded seam is greater than about 1.5.

20. The inflatable article of claim 15 wherein the first and second materials are bonded together to form a welded seam having a break strength greater than about 20 pli.

21. The inflatable article of claim 15 wherein the first and second materials are bonded together to form a welded seam having a break strength greater than about 30 pli.

22. An article comprising:
a first material and a second material joined at a welded seam;
the first material comprising a first thermoplastic polyurethane,
the second material comprising a laminate of an ePTFE membrane and a textile layer, the laminate having a weight of less than about 10 oz/yd²; and
a reinforcing layer comprising a second thermoplastic polyurethane bonded to a portion of the textile of the second material layer to form a reinforcing region;
wherein the welded seam, formed by bonding the first and second thermoplastic polyurethanes together, having a peel strength greater than about 25 pli.

23. The article of claim 22 wherein the article is an inflatable article.
